(19) United States
(12) Patent Application Publication
(10) Pub. No.: US 2020/0286173 A1
(43) Pub. Date: Sep. 10, 2020

(54) SYSTEM AND METHOD FOR DETERMINING A PRICE OF AN OBJECT IN A RESTRICTED ENVIRONMENT

(71) Applicant: Bellion Clofe Technologies (Pte. Ltd.), Singapore (SG)

(72) Inventor: Mervyn LAU, Singapore (SG)

(21) Appl. No.: 16/765,461

(22) PCT Filed: Dec. 22, 2017
(86) PCT No.: PCT/SG2017/050642

§ 371 Date: May 19, 2020

(51) Int. Cl. G06Q 40/04; G06Q 20/40; A63F 13/792

(52) U.S. Cl. CPC G06Q 40/04; H04L 67/42; A63F 13/792; G06Q 20/405

(57) ABSTRACT

The present invention provide users with an equitable manner of determining a price of an object in a restricted environment. The invention is able to provide equitable dynamic pricings for objects in a restricted environment in relation to a variety of events which affect the pricings of the objects.

### FIELD OF THE INVENTION

The present invention relates to a system and method for determining a price of an object in a restricted environment.

### BACKGROUND

There are many difficulties in relation to determining a price of an object when the object is not traded pursuant to open market forces. Typically, in an open market environment, the price of an object is determined primarily by supply-and-demand factors (and not directly dependent on occurrences of events), whereby demand for the object varies at different price-points. In a restricted environment where there is a plurality of objects available for selection, and whereby the prices of the objects are dynamic in relation to occurrences of events, it is difficult to determine an equitable price for the respective objects. Whether a price is equitable is subjective, but in an ideal situation, the equitable price would be determined by supply and demand forces as well as actual performance (of respective objects) metrics.

There are some methodologies currently deployed to determine respective prices for various objects in a restricted environment, typically in the gaming industry. However, in those circumstances, the methodologies typically favour the gaming entity, whereby the gaming entity is usually able to derive optimal benefit from the price movements of the various objects. In addition, the existing methodologies also typically focus on earning a commission from the spread of odds given that players are wagering on odds and the gaming entity needs to adjust the odds in a manner (artificially) in order to optimise profits/minimise losses. Furthermore, the existing methodologies focus on adjusting prices based on a subjective predictive model dependent on an expected (statistically driven) outcome of an event, and not real-time supply/demand/performance of an object. Therefore the odds, while sometimes also reflective of perceived supply/demand, does not actually take into account real-time and actual supply/demand and performance metrics.

In this regard, there is currently a lack of a method/system to ensure equitable dynamic pricings for objects in a restricted environment, whereby the method/system is not biased towards any player partaking in the restricted environment.

### SUMMARY

The summary includes the use of acronyms which are used in the rest of the specification.

In a first aspect, there is provided a system for carrying out an IBO for a tradeable object in a restricted environment, the system including at least one data processor configured to:
receive, from a user device, an IBR;
process, at the central server, the IBR such that a UIBOID is associated with the IBR;
determine, at the central server, if FM is sufficient to carry out the IBR;
process, at the central server, PE and at least one SE designations for respective objects in the restricted environment;
determine, at the central server, a cbPrice for the PE;
process, at the central server, the IBO;
transmit, from the central server, an OTP resulting from the IBO, enabling a user dashboard to be updated;
process, at the central server, a PCO Stack in accordance with predefined rules; process, at the central server, respective prices of the PE and at least one SE;
update, at the central server, the respective prices of the PE and at least one SE; and
determine, at the central server, if there are changes in the respective prices of the PE and at least one SE. Preferably, the PCO Stack is processed by re-sorting PCOs based on firstly, specified price of PCOs, and secondly, chronology of creation of PCOs.

In a second aspect, there is provided a data-processor implemented method for carrying out an IBO for a tradeable object in a restricted environment. The method comprises:
receiving, from a user device, an IBR;
processing, at the central server, the IBR such that a UIBOID is associated with the IBR;
determining, at the central server, if FM is sufficient to carry out the IBR;
processing, at the central server, PE and at least one SE designations for respective objects in the restricted environment;
determining, at the central server, a cbPrice for the PE;
processing, at the central server, the IBO;
transmitting, from the central server, an OTP resulting from the IBO, enabling a user dashboard to be updated;
processing, at the central server, a PCO Stack in accordance with predefined rules;
processing, at the central server, respective prices of the PE and at least one SE;
updating, at the central server, the respective prices of the PE and at least one SE; and
determining, at the central server, if there are changes in the respective prices of the PE and at least one SE. It is preferable that the PCO Stack is processed by re-sorting PCOs based on firstly, specified price of PCOs, and secondly, chronology of creation of PCOs.

In a third aspect, there is provided a non-transitory computer readable storage medium embodying thereon a program of computer readable instructions which, when executed by one or more processors of a central server, in communication with a plurality of user devices, cause the central server to carry out a method for carrying out an IBO for a tradeable object in a restricted environment.

The method embodies the steps of:
receiving, from a user device, an IBR;
processing, the IBR such that a UIBOID is associated with the IBR;
determining, if FM is sufficient to carry out the IBR;
processing, PE and at least one SE designations for respective objects in the restricted environment;
determining, a cbPrice for the PE;
processing, the IBO;
transmitting, an OTP resulting from the IBO, enabling a user dashboard to be updated;
processing, a PCO Stack in accordance with predefined rules;
processing, respective prices of the PE and at least one SE;
updating, the respective prices of the PE and at least one SE; and
determining, if there are changes in the respective prices of the PE and at least one SE. It is preferable that the PCO Stack is processed by re-sorting PCOs based on firstly, specified price of PCOs, and secondly, chronology of creation of PCOs.

In a fourth aspect, there is provided a system for carrying out an ICP for a tradeable object in a restricted environment, the system including at least one data processor configured to:
receive, from a user device, an ICR;
process, at a central server, the ICR such that a UIBOID is associated with the ICR;
process, at the central server, the ICR such that a UICOID is associated with the ICR;
process, at the central server, PE and at least one SE designations for respective objects in the restricted environment;
determine, at the central server, a ccPrice for the PE;
process, at the central server, the ICP;
transmit, from the central server, a CTP resulting from the ICP, enabling a user dashboard to be updated;
process, at the central server, a PCO Stack in accordance with predefined rules;
process, at the central server, respective prices of the PE and at least one SE;
update, at the central server, the respective prices of the PE and at least one SE; and
determine, at the central server, if there are changes in the respective prices of the PE and at least one SE. Preferably, the PCO Stack is processed by re-sorting PCOs based on firstly, specified price of PCOs, and secondly, chronology of creation of PCOs.

In a further aspect, there is provided a data-processor implemented method for carrying out an ICP for a tradeable object in a restricted environment. The method includes:
receiving, from a user device, an ICR;
processing, at a central server, the ICR such that a UIBOID is associated with the ICR;
processing, at the central server, the ICR such that a UICOID is associated with the ICR;
processing, at the central server, PE and at least one SE designations for respective objects in the restricted environment;
determining, at the central server, a ccPrice for the PE;
processing, at the central server, the ICP;
transmitting, from the central server, a CTP resulting from the ICP, enabling a user dashboard to be updated;
processing, at the central server, a PCO Stack in accordance with predefined rules;
processing, at the central server, respective prices of the PE and at least one SE;
updating, at the central server, the respective prices of the PE and at least one SE; and
determining, at the central server, if there are changes in the respective prices of the PE and at least one SE. It is preferable that the PCO Stack is processed by re-sorting PCOs based on firstly, specified price of PCOs, and secondly, chronology of creation of PCOs.

There is also provided a non-transitory computer readable storage medium embodying thereon a program of computer readable instructions which, when executed by one or more processors of a central server, in communication with a plurality of user devices, cause the central server to carry out a method for carrying out an ICP for a tradeable object in a restricted environment. The method embodies the steps of:
receiving, from a user device, an ICR;
processing, the ICR such that a UIBOID is associated with the ICR;
processing, the ICR such that a UICOID is associated with the ICR;
processing, PE and at least one SE designations for respective objects in the restricted environment;
determining, a ccPrice for the PE;
processing, the ICP;
transmitting, a CTP resulting from the ICP, enabling a user dashboard to be updated;
processing, a PCO Stack in accordance with predefined rules;
processing, respective prices of the PE and at least one SE;
updating, the respective prices of the PE and at least one SE; and
determining, if there are changes in the respective prices of the PE and at least one SE.

Preferably, the PCO Stack is processed by re-sorting PCOs based on firstly, specified price of PCOs, and secondly, chronology of creation of PCOs.

Furthermore, another aspect is a system for carrying out a PBO for a tradeable object in a restricted environment, the system including at least one data processor configured to:
receive, from a user device, a PBR;
process, at a central server, the PBR such that a UPBOID is associated with the PBR;
process, at the central server, the PBO for storing at a PBO Stack; and
transmit, to the user device, information of the PBO, enabling a user dashboard to be updated. The PBO Stack is preferably processed by re-sorting PBOs based on firstly, specified price of PBO, and secondly, chronology of creation of PBOs.

There is also provided a data-processor implemented method for carrying out a PBO for a tradeable object in a restricted environment, the method including:
receiving, from a user device, a PBR;
processing, at a central server, the PBR such that a UPBOID is associated with the PBR;
processing, at the central server, the PBO for storing at a PBO Stack; and
transmitting, to the user device, information of the PBO, enabling a user dashboard to be updated. The PBO Stack is preferably processed by re-sorting PBOs based on firstly, specified price of PBO, and secondly, chronology of creation of PBOs.

A further aspect provides a non-transitory computer readable storage medium embodying thereon a program of computer readable instructions which, when executed by one or more processors of a central server, in communication with a plurality of user devices, cause the central server to carry out a method for carrying out a PBO for a tradeable object in a restricted environment. The method embodies the steps of:
receiving, from a user device, a PBR;
processing, the PBR such that a UPBOID is associated with the PBR;
processing, the PBO for storing at a PBO Stack; and
transmitting, to the user device, information of the PBO, enabling a user dashboard to be updated. It is preferable that the PBO Stack is processed by re-sorting PBOs based on firstly, specified price of PBO, and secondly, chronology of creation of PBOs.

Another aspect provides a system for carrying out a pending order triggered from price movements of a tradeable object, the system including at least one data processor configured to:
determine, at a central server, a Price Movement;
determine, at the central server, whether to activate a PBO and/or PCO within a range of the Price Movement;
activate, at the central server, either a PBO or a PCO;
transmit, from the central server, an Open Trade Position and/or the Closed Trade Position, enabling a user dashboard to be updated;
determine, at the central server, an NPD, the NPD being the difference between all successfully executed PBOs and all successfully executed PCOs from the Price Movement;
activate, at the central server, a IBP, a ICP or a NULL position;
process, at the central server, respective prices of a PE and at least one SE; and
update, at the central server, the respective prices of the PE and at least one SE.

There is also provided a data-processor implemented method for carrying out a pending order triggered from price movements of a tradeable object, the method including:
determining, at a central server, a Price Movement;
determining, at the central server, whether to activate a PBO or PCO within a range of the Price Movement;
activating, at the central server, either a PBO or a PCO;
transmitting, from the central server, an Open Trade Position and/or the Closed Trade Position, enabling a user dashboard to be updated;
determining, at the central server, an NPD, the NPD being the difference between all successfully executed PBOs and all successfully executed PCOs from the Price Movement;
activating, at the central server, a IBP, a ICP or a NULL position;
processing, at the central server, respective prices of a PE and at least one SE; and
updating, at the central server, the respective prices of the PE and at least one SE.

Another aspect provides a non-transitory computer readable storage medium embodying thereon a program of computer readable instructions which, when executed by one or more processors of a central server, in communication with a plurality of user devices, cause the central server to carry out a method for carrying out a pending order triggered from price movements of a tradeable object. The method embodies the steps of:
determining, a Price Movement;
determining, whether to activate a PBO or PCO within a range of the Price Movement;
activating, either a PBO or a PCO;
transmitting, an Open Trade Position and/or the Closed Trade Position, enabling a user dashboard to be updated;
determining, an NPD, the NPD being the difference between all successfully executed PBOs and all successfully executed PCOs from the Price Movement;
activating, a IBP, a ICP or a NULL position;
processing, respective prices of a PE and at least one SE; and
updating, the respective prices of the PE and at least one SE.

A further aspect provides a system for carrying out a price change for a tradeable object based on occurrence of Milestone Conditions, the system including at least one data processor configured to:
receive, from a feed server, feed data for every occurrence of the Milestone Condition; process, at a central server, each Milestone Condition and associating a UMCID to the Milestone Condition;
process, at the central server, each Milestone Condition to identify a relevant PE; determine, at the central server, price changes for the relevant PE and at least one SE;
update, at the central server, the price changes; and
update, at a user device, the prices changes.

A penultimate aspect provides a data processor implemented method for carrying out a price change for a tradeable object based on occurrence of Milestone Conditions, the method including:
receiving, from a feed server, feed data for every occurrence of the Milestone Condition; processing, at a central server, each Milestone Condition and associating a UMCID to the Milestone Condition;
processing, at the central server, each Milestone Condition to identify a relevant PE;
determining, at the central server, price changes for the relevant PE and at least one SE;
updating, at the central server, the price changes; and
updating, at a user device, the prices changes.

A final aspect provides a non-transitory computer readable storage medium embodying thereon a program of computer readable instructions which, when executed by one or more processors of a central server, in communication with a plurality of user devices, cause the central server to carry out a method for carrying out a price change for a tradeable object based on occurrence of Milestone Conditions. The method embodies the steps of:
receiving, from a feed server, feed data for every occurrence of the Milestone Condition;
processing, each Milestone Condition and associating a UMCID to the Milestone Condition;
processing, each Milestone Condition to identify a relevant PE; determining, price changes for the relevant PE and at least one SE;
updating, the price changes.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

A non-limiting example of the present invention will now be described with reference to the accompanying drawings, in which:

FIG. 1 is a schematic diagram of an example of a system for the present invention;

FIG. 2 is a schematic diagram showing components of an example user device of the system shown in FIG. 1;

FIG. 3 is a schematic diagram showing components of an example server shown in FIG. 1;

FIGS. 4A to 4B show a flow chart of an example of a method for carrying out an instant buy order;

FIGS. 5A and 5B show a flow chart of an example of a method for carrying out an instant close position;

FIG. 6 shows a flow chart of an example of a method for carrying out a pending buy order;

FIGS. 7A and 7B show a flow chart of an example of a method for carrying out a pending order triggered from price movements of a tradeable object;

FIG. 8 shows a flow chart of an example of a method for carrying out a price change for a tradeable object based on occurrence of Milestone Conditions; and

FIG. 9 shows an example of a graphical user interface of a game-play segment of a software enabled by embodiments of the present invention.

### LISTING OF ACRONYMS USED IN THE DETAILED DESCRIPTION

For avoidance of doubt and to distinguish from similar acronyms currently in use and to ensure better readability for the contents of the detailed description, the following acronyms referred to in the detailed description are provided in alphabetical order:
cbPrice: Current Buy Price
ccPrice: Current Close Price
CTP: Close Trade Position
FM: Free Margin
IBO: Instant Buy Order
IBP: Instant Buy Position
IBR: Instant Buy Request
ICP: Instant Close Position;
ICR: Instant Close Request
OTP: Open Trade Position
NPD: Nett Position Difference
PBO: Pending Buy Order
PBR: Pending Buy Request
PCO: Pending Close Order
PO: Pending Order
PE: Primary Entity
S-GER: System-Generated Error Result
scoPrice: Specific Custom Open Price
SCP: Specified Custom Price
SE: Secondary Entity
SLO: Stop-Loss Order
TPO: Take-Profit Order
UIBOID—Unique Instant Buy Order ID
UICOID: Unique Instant Close Order ID
UGAD: User Game Account Database
UMCID: Unique Milestone Condition ID
UPBOID: Unique Pending Buy Order ID

### DETAILED DESCRIPTION

Embodiments of the present invention provide users with an equitable manner of determining a price of an object in a restricted environment. The invention is able to provide equitable dynamic pricings for objects in a restricted environment in relation to a variety of events which affect the pricings of the objects.

In the following paragraphs, basic examples of various methods of determining a price of an object in a restricted environment will be described with reference to respective associated FIGs as indicated in the following paragraphs. For the purposes of illustration, it is assumed that the method can be performed at least in part using one or more electronic processing devices which form part of any data processing apparatus.

It should be appreciated that embodiments of the present invention are carried out in a restricted environment, whereby constraints are placed on a number of objects that can be traded in the restricted environment. In addition, trading in the restricted environment is only accessible to parties who have access privileges to the restricted environment. It should be appreciated that the access privileges can be, for example, by payment of a fee, by pre-registration, by a designated invitation and so forth. The restricted environment can be, for example, a game instance, an object trading instance, and so forth.

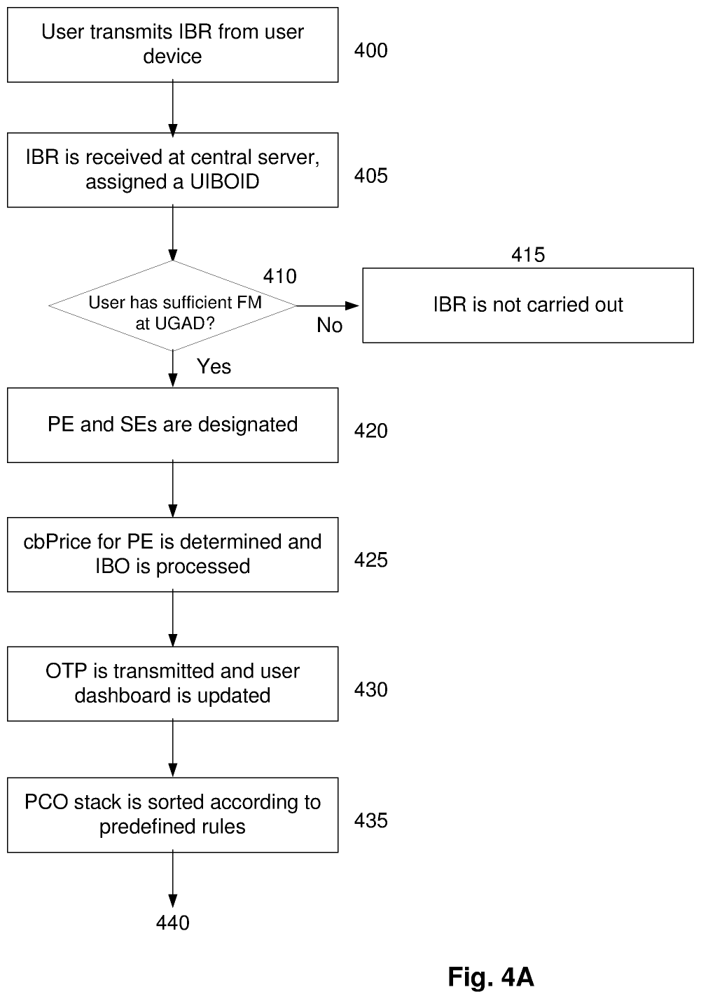

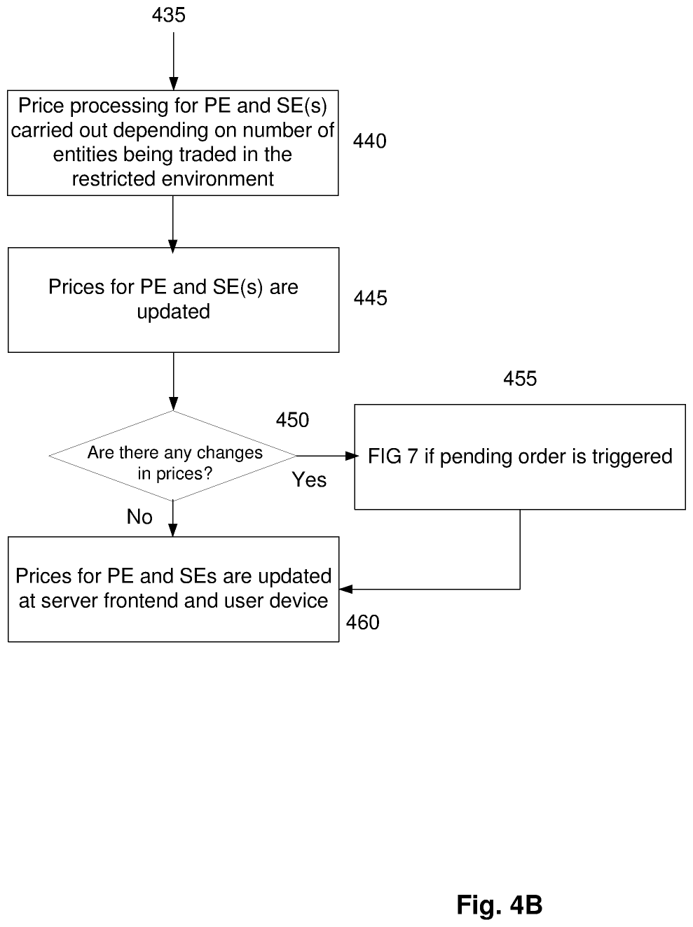

Referring to FIG. 4, there is provided an example of a method for carrying out an instant buy order (IBO) for a tradeable object in a restricted environment.

At step 400, a user transmits, from a user device, an Instant Buy Order (IBO) for n Units (nUnits) of a tradeable object A at a Current Buy Price (cbPrice), with Take-Profit Order (TPO) and Stop-Loss Order (SLO). This transmission can be collectively referred to as the user's Instant Buy Request (IBR).

At step 405, once the IBR is received at a central server, the IBR is forwarded to a backend for processing. At the backend, the IBR is assigned a Unique Instant Buy Order ID (UIBOID). At step 410, a User Game Account Database (UGAD) at the central server and is checked to determine if the user has sufficient Free Margin (FM) to carry out the IBR. If the user has insufficient FM, the IBR is not carried out at step 415, resulting in a System-Generated Error Result (S-GER) being transmitted to the central server frontend and also stored in the user's game transaction history log, which can be accessible at the user device.

If the user has sufficient FM, at step 420, the tradeable object A of the IBR is identified as Primary Entity (PE) with other objects being classified as Secondary Entities (SEs), whereby processing is carried out at the central server backend.

Subsequently, at step 425, the IBO is executed at the backend, whereby the IBO for tradeable object A is matched and fixed with a cbPrice of the tradeable object A in the backend. It should be appreciated that only at this juncture where the cbPrice is given a definite value (i.e. fixed) to account for situational variation during earlier steps. When the IBO is processed, the following occurs:

i. The user's IBO for is fully and completely opened in the backend, resulting in an Open Trade Position (OTP); and

ii. The TPO and the SLO, part of the IBR, are classified and converted into Pending Close Orders (PCO) and placed in the PCO Stack in the backend. This is done by, creating a Unique Take-Profit ID for the TPO, and a Unique Stop-Loss ID for the SLO (both are associated with an ID of the IBO), and creating PCOs identical to the TPO and SLO.

At step 430, the OTP will be transmitted from the central server to the user device, and updated in the frontend, thus displaying an open position for the PE in the user's current trade positions dashboard. The dashboard includes the following details, for example, IBO ID, PE name, nUnits, opening price, current price, take-profit value, stop-loss value, profit/loss, time of IBO, duration of trade, and so forth.

At step 435, processing at the central server (backend) is carried out, whereby the PCO Stack is sorted to account for the new additions of the TPO and SLO based on the following rules (in order of priority):

i. Sorting first, PCOs based on a SCP; and

ii. Sorting second, PCOs based on chronology of creation.

At step 440, processing is carried out at the central server (backend), an algorithm is applied for an IBO for n Units at cbPrice of tradeable object A. This is carried out by:

i. Identifying W=[Ranking Value of object for IBO Application] and V=[Base Value allocated unique to a particular restricted environment];

ii. Applying first, a Price Reduction:

a. If Head-to-Head (where there are two objects in the restricted environment); for object B (SE) based on {((W*V)%*Price of object B prior to the IBO being accounted for}; (the Price Reduction for object B=“BBY”), or

b. If Multi-Head (where there are more than two objects in the restricted environment); for each respective SEs based on {((W*V)%*Price of object in question prior to the IBO being accounted for)/Number of SEs}; and

c. Then, applying a Price Increase for PE based on the BBY, or where Multi-Head XXY (XXY=sum of all Price Reductions from SEs);

At step 445, processing at the central server (backend) is carried out to update the change in prices for the PE and SEs after application of the algorithm and effectuation of the formula.

A recurring process occurs at step 455 after a change in prices for the PE and SE(s) are detected at step 450, to account for standing PBOs and PCOs. The recurring process includes:

1. Processing, at the central server (backend), when a change in Buy Price and Close Price is detected (known as “Price Movement”), a query is routed to both the PBO and PCO Stacks;

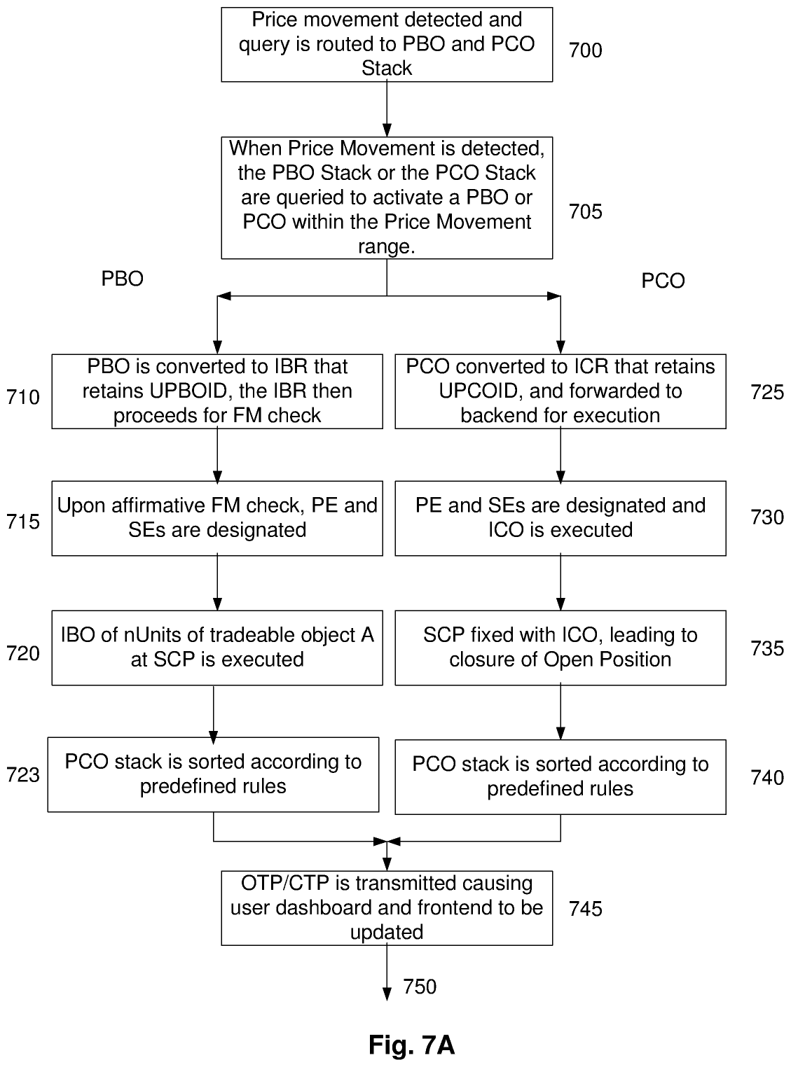

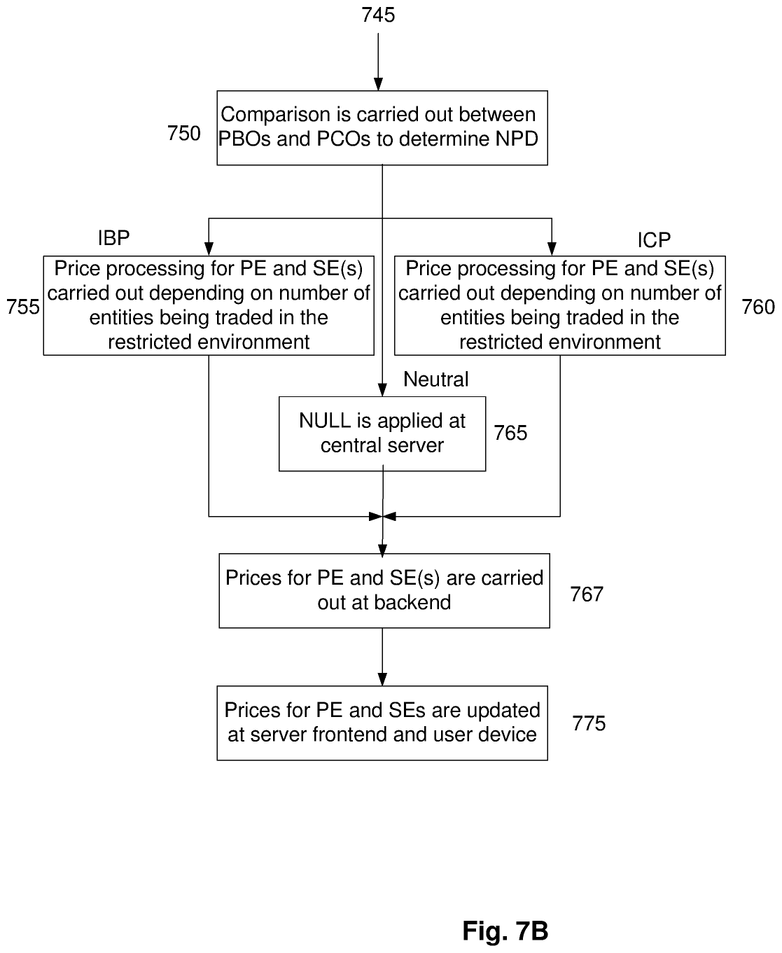

2. Processing, at the central server (backend), when a PBO in the PBO Stack has been triggered within the Price Movement threshold, the system will process the PBO(s) in the backend; and/or, when a PCO in the PCO Stack has been triggered within the Price Movement threshold, the system will process the PCO(s) in the backend (as depicted in FIG. 7) will be activated at step 455. It should be appreciated that these processes are linked to Price Movements.

At step 460, subsequently, the change in prices for tradeable objects A and B are updated at the frontend and the user device (via transmission to user device).

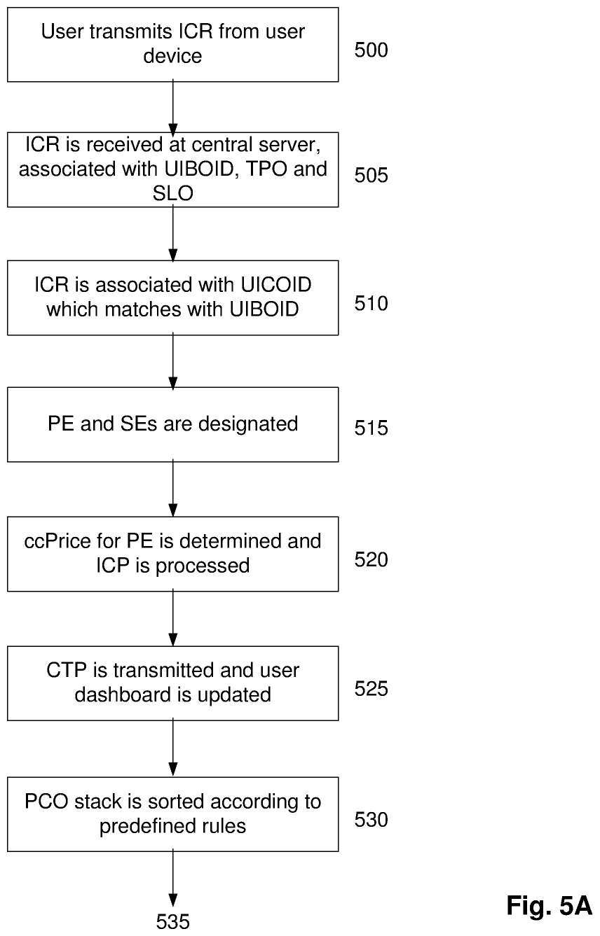

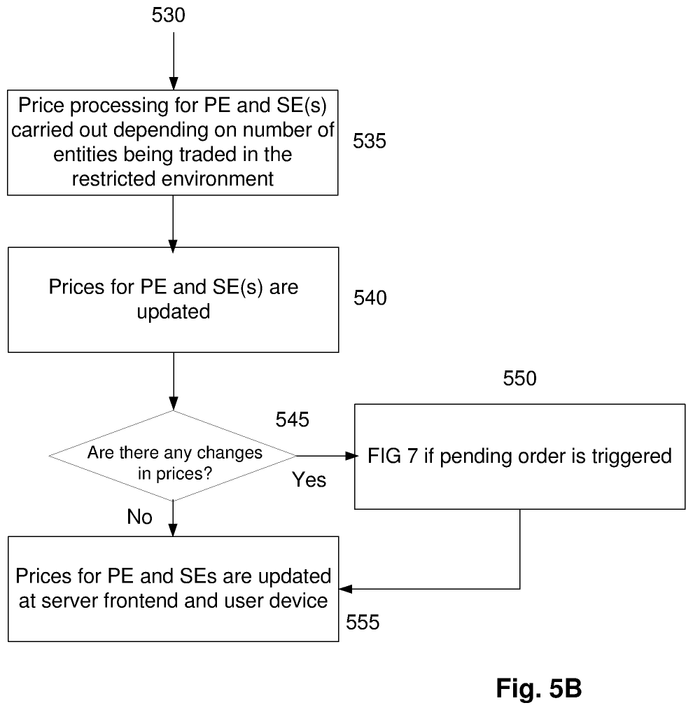

Referring to FIG. 5, there is provided an example of a method for carrying out an instant close position (ICP) for a tradeable object in a restricted environment.

At step 500, a user transmits, from a user device, an Instant Close Position (ICP) of an existing Open Position for n Units (nUnits) of a tradeable object A at a Current Close Price (ccPrice). This transmission can be collectively referred to as the user's Instant Close Request (ICR).

At step 505, once the ICR is received at the central server, the ICR is forwarded to the backend for processing. Subsequently, the UIBOID (provided earlier in FIG. 4) is associated with the ICR, together with the corresponding TPO and SLO belonging to the existing Open Position generated from the IBO of FIG. 4 which are subsisting in the PCO stack.

At step 510, processing at the central server is carried out to associate the ICR to a Unique Instant Close Order ID (UICOID) that matches the corresponding UIBOID (e.g. UIBOID=IB 001, UICID=IC 001). Subsequently, the PE and SE(s) of the ICR are designated at step 515.

Furthermore, at step 520, a ccPrice of the tradeable object A is determined for n Units of the Instant Close Position (ICP) and is fixed at the backend. It should be appreciated that it is only at this juncture where the ccPrice is given a definite value (i.e. fixed) to account for situational variation during earlier steps. The ICP is then processed, which results in the following:

i. The prior Open Position is closed/terminated in the backend; and

ii. The corresponding TPO and SLO associated with the prior Open Position, are removed from the PCO Stack in the backend.

At step 525, information on a Close Trade Position (CTP) is transmitted from the central server to the frontend and user device, thus displaying the CTP information in the user's trade position history dashboard. The dashboard includes the following details, for example, ICP ID, PE name, nUnits, opening price, closed price, take-profit value, stop-loss value, profit/loss, duration of trade, time of close, and so forth.

Further, at step 530, processing at the central server (backend) is carried out, whereby PCO Stack is sorted to account for the removal of the TPO and SLO based on the following rules (in order of priority):

i. Sorting first, PCOs based on SCP; and

ii. Sorting second, PCOs based on chronology of creation.

At step 535, processing is carried out at the central server backend, an Algorithm is applied for an ICP for n units at ccPrice of tradeable object A. This is carried out by:

i. Identifying Y=[Ranking Value of object for ICP Application] and V=[Base Value allocated unique to a particular restricted environment];

ii. Applying first, a Price Reduction:

a. If Head-to-Head (where there are two objects in the restricted environment); for object A (PE) based on {(Y*V)%*Price of object A prior to the ICP being accounted for}; (the Price Reduction for object A=“AY”), or

b. If Multi-Head (where there are more than two objects in the restricted environment); for object A (PE) based on {(Y*V)%*Price of object A prior to the ICP being accounted for}; (the Price Reduction for object A=“AY”); and

c. Then, applying a Price Increase if,

1. Head-to-Head; for object B (SE) based on AY, or

2. Multi-Head, for each SE based on {AY/Number of SEs}.

At step 540, processing at the central server (backend), is carried out to update the change in prices for the PE and SEs after application of the algorithm and effectuation of the formula.

A recurring process occurs at step 545 after a change in prices for the PE and SE(s) are detected at step 540, to account for standing PBOs and PCO. The recurring process includes:

1. Processing, at the central server (backend), when a Change in Buy price and Close Price is detected (known as “Price Movement”), a query is routed to both the PBO and PCO Stacks;

2. Processing, at the central server (backend), when a PBO in the PBO Stack has been triggered within the Price Movement threshold, the system will process the PBO(s) in the backend; and/or, when a PCO in the PCO Stack has been triggered within the Price Movement threshold, the system will process the PCO(s) in the backend (as depicted in FIG. 7) will be activated at step 550. It should be appreciated that these processes are linked to price movements.

At step 555, subsequently, the change in prices for tradeable objects A and B are updated at the frontend and the user device (via transmission to user device).

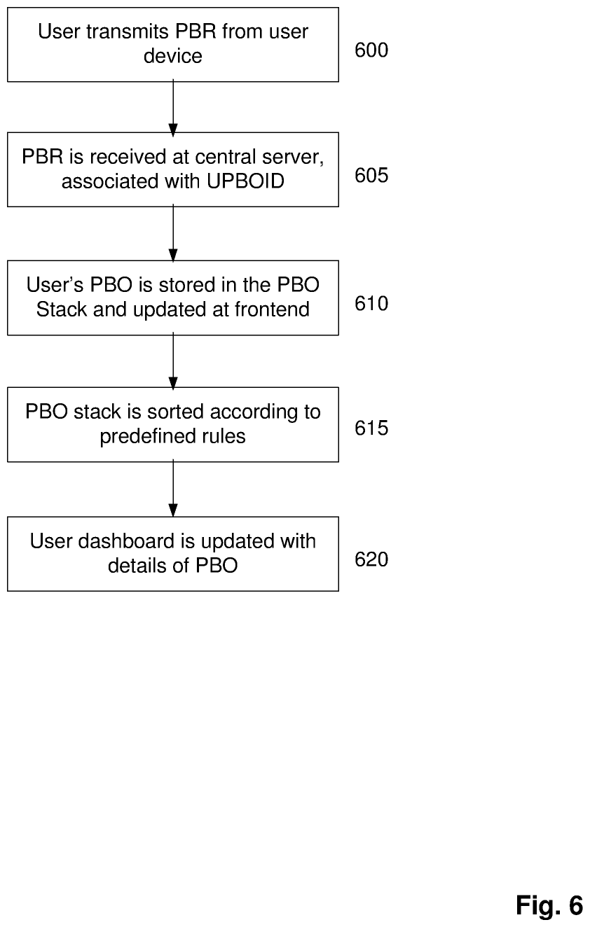

Referring to FIG. 6, there is provided an example of a method for carrying out a PBO for a tradeable object in a restricted environment.

At step 600, a user transmits, from a user device, a PBO for n Units (nUnits) of tradeable object A at a Specified Custom Open Price (scoPrice) with TPO and SLO. This transmission is collectively referred to as the user's Pending Buy Request (PBR).

At step 605, once the PBR is received at the central server, the PBR is forwarded to the backend for processing. Subsequently, a Unique Pending Buy Order ID (UPBOID) is associated with the PBR.

Furthermore, at step 610, the user's PBO is stored in the PBO Stack at the central server (backend) and the PBO is updated at the frontend. Subsequently, at step 615, processing at the central server (backend) is carried out, whereby the PBO Stack is sorted to account for the new PBO based on the following rules (in order of priority):

i. Sorting first, PBOs based on SCP; and

ii. Sorting second, PBOs based on chronology of creation.

Moreover, at step 620, the user device receives, at a display of the user's Pending Trade Orders dashboard, details of a PBO for tradeable object A including, for example, UPBOID, PE name, nUnits, scoPrice, current price, take-profit value, stop-loss value, time of order, duration of order, and so forth.

Referring to FIG. 7, there is provided an example of a method for carrying out a PO triggered from price movements of a tradeable object.

At step 700, processing is carried out at the central server (backend) to detect a change in Buy Price (BP) and Close Price (CP) (Price Movement). A query is then routed to the PBO Stack and the PCO Stack.

At step 705, when the Price Movement is detected, the PBO Stack and the PCO Stack are queried to determine, and where applicable, trigger a PBO(s) and/or a PCO(s) within the Price Movement range.

At step 710, when either a PBO and/or a PCO is successfully matched within the Price Movement range, a respective PO will be triggered for the corresponding User(s).

PBO TRIGGERED

If a PBO was triggered for the user, processing is carried out at step 710 at the central server (backend), where the user's PBO is converted into an IBR but retains the same UPBOID that was previously assigned during the creation of the PBO. The IBR is then forwarded for a FM check at the UGAD at the central server (backend), to confirm if the user has sufficient FM available to execute an IBO for nUnits at SCP of tradeable object A. If yes, the FM check is answered in the affirmative and the backend routes the user's IBR for further processing at step 715. If no, the FM check is answered in the negative, resulting in the following:

1. Transmission of a S-GER from backend to Frontend; and

2. Reception of a S-GER message in the user's trade history log (e.g. PBO triggered, BO unsuccessful; Reason: Insufficient FM).

At step 715, upon an affirmative FM check, processing is carried out at the central server backend) to designate the PE and SE(s) of the IBR—tradeable object A is identified and designated as the PE with the remaining objects in the restricted environment being identified and designated as SE(s).

Subsequently, at step 720, the IBO of nUnits of the tradeable object A at SCP is executed at the backend. Once the SCP is definitively fixed with the IBO, processing, is carried out at the central server (backend), resulting in the following simultaneous nett effects:

a. The user's IBR is now fully and completely opened in the backend, resulting in an OTP; and

b. The TPO and SLO, part of the PBO, which have been retained after the conversion of the PBO into the IBR, are classified and converted into PCOs and placed in the PCO Stack in the backend. This is done by, creating a Unique Take-Profit ID for the TPO and a Unique Stop-Loss ID for the SLO (both are associated with the UIBOID), and creating PCOs identical to the TPO and SLO.

At step 723, processing at the central server (backend) is carried out to sort the PCO Stack to account for the new additions of the TPO and SLO based on the following rules (in order of priority):

i. Sorting first, PCOs based on SCP; and

ii. Sorting second, PCOs based on chronology of creation.

PCO TRIGGERED

If PCO (i.e. Take-Profit or Stop-Loss) was triggered for the user, processing is carried out at step 725 at the central server (backend), where the user's PCO is converted into an ICR but retains the same UPCOID that was previously assigned during the creation of the PCO. The ICR with the UPCOID is then forwarded to the backend for execution. Subsequently, the PE and SE(s) of the ICR are designated at step 730 and the ICP of nUnits at SCP of tradeable object A is executed at the backend.

At step 735, once the SCP has been definitively fixed with the user's ICP, the previously Open Position will be Closed in the backend, resulting in the following simultaneous nett effects:

a. The user's previously Open Position is now fully and completely Closed/Terminated in the backend; and

b. The corresponding TPO and SLO, associated with the previous Open Position, are both removed from the PCO Stack in the backend.

At step 740, processing at the central server (backend) is carried out to sort the PCO Stack to account for the removal of the TPO and SLO based on the following rules (in order of priority):

a. Sorting first, PCOs based on SCP; and

b. Sorting second, PCOs based on chronology of creation.

At step 745, the Open Trade Position Information and/or the Close Trade Position is transmitted from the central server and the information will be updated in the frontend and the user device. For example, if a PBO was triggered, the display of an Open Position for tradeable object A is displayed in the user's current trade position dashboard. The dashboard includes the following details, for example, UIBOID, PE name, nUnits, opening price, current price, take-profit value, stop-loss value, profit/loss, time of open, duration of trade and so forth. If a PCO was triggered, the display of a Closed Position for tradeable object is displayed in user's trade position history dashboard. The dashboard includes the following details, for example, UICOID, PE name, nUnits, opening price, closed price, take-profit value, stop-loss value, profit/loss, time of open, time of close, and so forth.

Subsequently, at step 750, a comparison is carried out at the backend between successfully executed PBOs (i.e. IBOs) and PCOs (i.e. ICPs) to determine a Nett Position Difference (NPD) to be applied in the Algorithm. The NPD is determined by accounting for the difference between all successfully executed PBOs and all successfully executed PCOs from the latest Price Movement (step 700).

In accordance with the NPD, the algorithm applies the formula for either an IBO or ICP for nUnits at ccPrice of tradeable object A, or, where the NPD is neutral, a Null formula.

If the NPD is an IBP, at step 755, the algorithm applies the formula for an IBO for nUnits (where n=NPD) of tradeable object A (in order of priority):

a. Identify W=[Ranking Value of object for IBO Application] and V=[Base Value allocated unique to a particular restricted environment];

b. Applying first, a Price Reduction:

i. If Head-to-Head (where there are two objects in the restricted environment); for object B (SE) based on {(W*V)%*Price of object B prior to the IBO being accounted for}; (the Price Reduction for object B=“BBY”); or

ii. If Multi-Head (where there are more than two objects in the restricted environment); for all SEs based on {((W*V)%*Price of object in question prior to the IBO being accounted for)/Number of SEs}; and

c. Then, applying, a Price Increase for PE based on BBY, or where Multi-Head XXY (XXY=sum of all Price Reductions).

If the NPD is an ICP, at step 760, the algorithm applies the formula for an ICO for nUnits (where n=NPD) of tradeable object A (in order of priority):

a. Identify Y=[Ranking Value of object for ICP Application] and V=[Base Value allocated based on Number of Participants in a restricted environment];

b. Applying first, a Price Reduction:

i. If Head-to-Head (where there are two objects in the restricted environment); for object A (PE) based on {(Y*V)%*Price of object A prior to the ICP being accounted for}; (the Price Reduction for object A=“AY”), or

ii. If Multi-Head (where there are more than two objects in the restricted environment); for object A (PE) based on {(Y*V)%*Price of object A prior to the ICP being accounted for}; (the Price Reduction for object A=“AY”);

c. Then, applying a Price Increase:

i. If Head-to-Head; for object B (SE) based on AY, or

ii. If Multi-Head, for each SE based on {AY/Number of SEs}.

If the NPD is neutral, at step 765, the algorithm applies change of NULL at the central server (backend).

At step 767, updates to the change in prices for both objects A and B are carried out in the backend.

Subsequently, the change in prices for objects A and B in the backend will be updated in the Frontend and the user device at step 775.

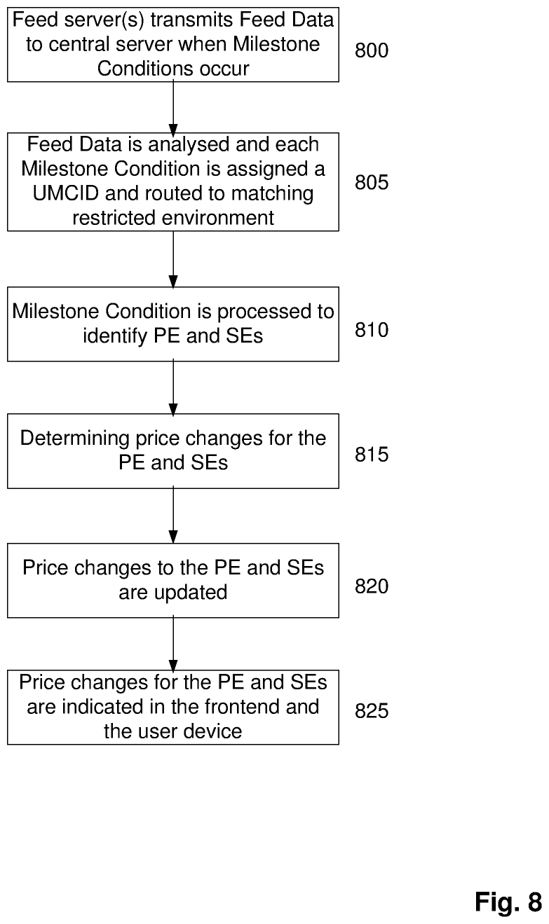

Referring to FIG. 8, there is provided an example of a method for carrying out a price change for a tradeable object based on occurrence of Milestone Conditions.

At step 800, feed servers administered by, a feed provider(s) transmits a data packet (Feed Data) to the central server whenever a Milestone Condition occurs in real time at an event, the event being of consequence to the restricted environment.

The Feed Data received at the central server is analysed at step 805, and relevant values will be extracted to constitute the Milestone Condition(s), whereby each Milestone Condition is assigned a Unique Milestone Condition ID (UMCID) and is routed to a matching restricted environment(s) in the central server (backend) database.

At step 810, the Milestone Condition is processed at the central server (backend) where it is queried by the event engine to identify the PE that the Milestone Condition ought to be allocated to, and identifies and classifies the remaining objects in the event as SEs.

Furthermore, at step 815, the algorithm applies the formula for the Milestone Condition of tradeable object A (in order of priority) (Whereby Z=Ranking Value of object, M=Condition Value of Milestone and V=Base Value allocated unique to a particular restricted environment):

i. Identify the number of objects in the restricted environment;

ii. Identify respective Rankings of the objects in the restricted environment based on each object's ccPrice;

iii. Identify a Z Value of each object based on the Ranking of each object in Ascending Order (e.g. If Price of object A>Price of object B, object A allocated Z=2, and object B allocated Z=1). If tied, the Z Values from the previous frame of time will be identified and applied instead;

iv. Identify a M Value;

v. Identify a V Value of the restricted environment which had been set by the Administrator at the creation of the restricted environment;

vi. Identify and fix each objects ccPrice;

vii. Applying first, a Price Reduction—

1. If Head-to-Head (where there are two objects in the restricted environment), determine if object A's Z Value is more than object B's Z Value. If yes, B's Z Value will be reduced to Z=Minimum Rank Value (eg. 1). Price Reduction for object B (BBY) is based on {(Minimum Rank Value*M*V)%*Price of object B prior to the Milestone Condition for object A being accounted for}. If no, B's Z Value=Specific Rank Value (eg. 2) will be retained from Step 815(iii) as detailed in the preceding portion of the description. Price Reduction for object B (BBY) is based on {(Specific Rank Value*M*V)%*Price of object B prior to the Milestone Condition for object A being accounted for}.

2. If Multi-Head (where there are more than two objects in the restricted environment); determine if object A's Z Value against all SEs is more or less compared to the other Z Values. If A's Z Value is more than an object X, object X's Z Value will be reduced to Z=Minimum Rank Value (eg. 1), and a Price Reduction for object X (XXY) is carried out based on {(Minimum Rank Value*M*V)%*Price of object X prior to the Milestone Condition for object A being accounted for/Number of Secondary objects}. If A's Z Value is less than an object Y, object Y's Rank Value will be retained from Step 815(iii) as detailed in the preceding portion of the description. Price Reduction for object B (YYY) is based on {(Specific Rank Value*M*V)%*Price of object Y prior to the Milestone Condition for object A being accounted for/Number of SEs}.

vii. Applying second, a Price Increase for the PE—If Head-to-Head; based on BBY , or if Multi-Head, based on a sum of all Price Reductions from SEs.

At step 820, the change in prices of the PE and SEs are updated at the central server backend. The following recurring process occurs after any change in prices is detected—When a Price Movement is detected, processing at the central server (backend) is carried out, whereby a query is routed to the PBO Stack and the PCO Stack. When a PBO in the PBO Stack has been triggered, the PBO will be processed accordingly in the backend and/or, when a PCO in the PCO Stack has been triggered, the PCO will be processed accordingly. The recurring process is described in further detail in step 700 to step 775.

At step 825, the change in prices for object A and B (or SEs) in the backend are updated and indicated in the frontend and the user device.

Accordingly, the above described method provides a number of advantages.

The abovementioned examples can be used together to provide a method for determining a price of an object in a restricted environment. The method is able to provide equitable dynamic pricings for objects in a restricted environment in relation to a variety of activities which affect the pricings of the objects. The dynamic nature of the price generation for the objects contribute to enhancing a user experience when the method is carried out. By using the method, there is no reliance on an “expected outcome” model, where the prices of odds are adjusted/biased to enable a bookmaker to earn a profit. Prices are determined by real-time factors such as actual demand and supply of objects as well as respective performance by objects. By using the method, there is no artificial or commercially driven intervention in relation to movement of prices after an initial starting price is determined. The method enables a free market system which reflects a true consensus/reflection of inherent “worth” and value of an object

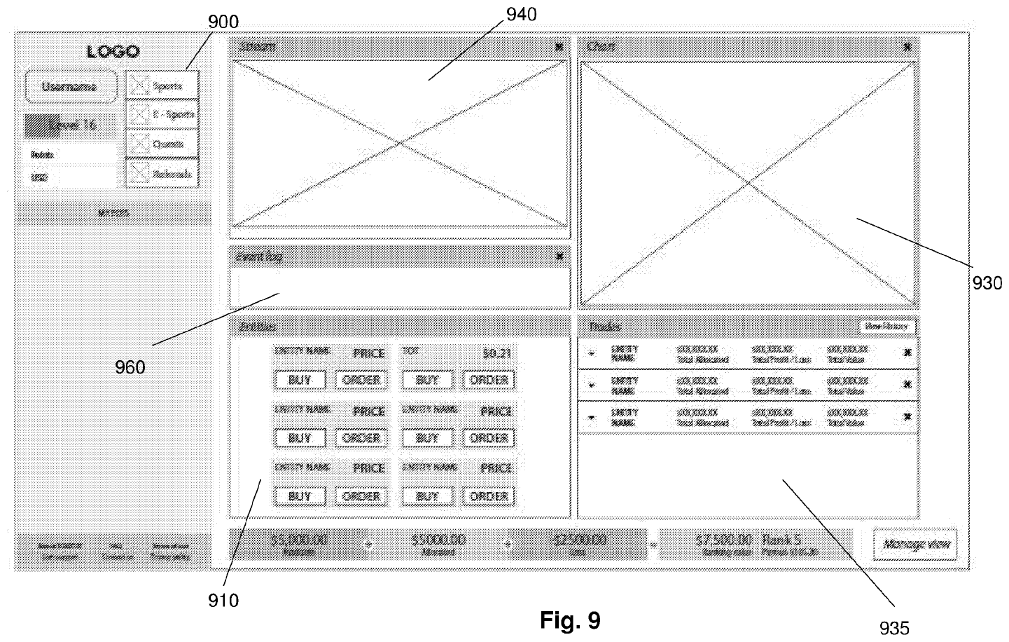

Referring to FIG. 9, there is shown an example of a user interface for a game-play segment of a software enabled by the methods as described in the preceding paragraphs. The user interface provides some context in relation to how the aforementioned methods are represented to a user.

There is provided a selection 900 of games which are available to the user. For example, the user can access games involving physical sport, or e-sports. A selection of the objects in a restricted environment is shown in box 910.

At an off-central portion 930 of the graphical user interface, a price movement chart over a predefined period of time of one of the selected objects is shown. Portion 935 also shows a record of trades that the user has carried out, and news window 940 which would indicate UMCIDs). A log of the UMCIDs is also shown at a central portion 960.

It should be appreciated that the interface is primarily to provide the user with an indication of the current goings-on in the restricted environment, such that the user is able to make a calculated decision on choices to be made to optimise returns (could be legal tender currency or non-legal tender credits) from the restricted environment.

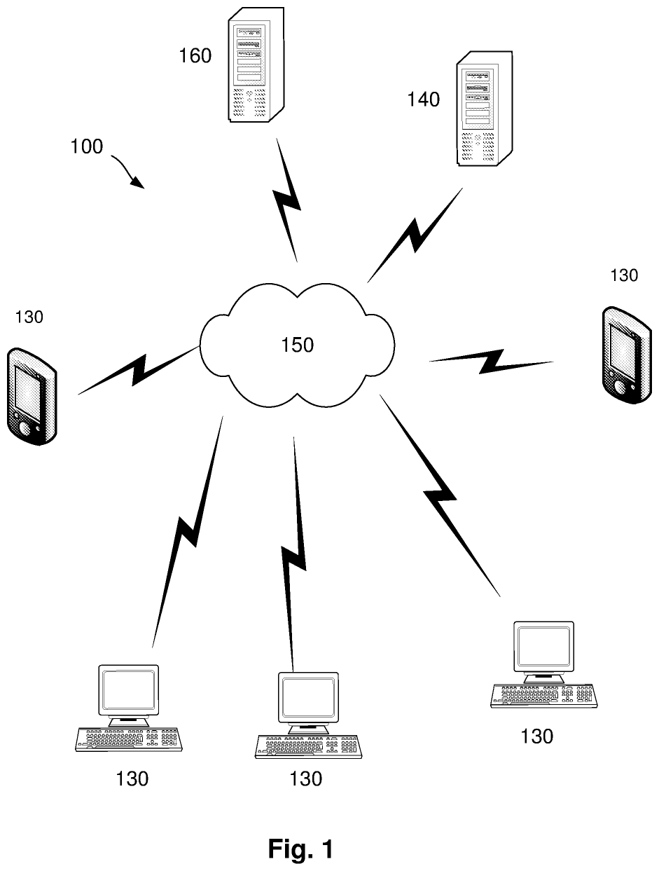

An example of a system 100 for carrying out the aforementioned methods (whether individually or in any combination) will now be described with reference to FIG. 1.

In this example, the system 100 includes one or more user devices 130, a communications network 150, a central server 140 (can also be a cluster/plurality of servers) and at least one feed server 160. In some embodiments, the central server 140 can be administered by an entity which hosts the restricted environment as discussed earlier.

The communications network 150 can be of any appropriate form, such as the Internet and/or a number of local area networks (LANs). It will be appreciated that the configuration shown in FIG. 1 is for the purpose of example only, and in practice the user devices 130, the feed server 160 and the central server 140 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like.

### User Device 130

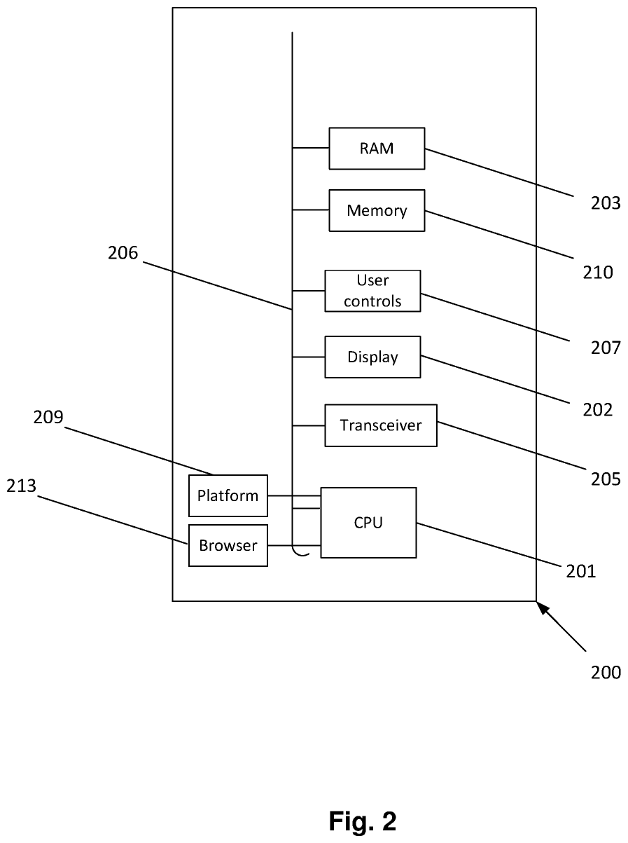

The user device 130 of any of the examples herein may be a desktop, a laptop, a hybrid, mobile phone, tablet and the like. An exemplary embodiment of a user device 200 is shown in FIG. 2. As shown, the user device 200 includes the following components in electronic communication via a bus 206:

1. a display 202;

2. non-volatile memory 210;

3. random access memory (“RAM”) 203;

4. N processing components 201;

5. a transceiver component 205 that includes N transceivers; and

6. user controls 207.

Although the components depicted in FIG. 2 represent physical components, FIG. 2 is not intended to be a hardware diagram; thus many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 202 generally operates to provide a presentation of content to a user, and may be realized by any of a variety of displays (e.g., CRT, LCD, HDMI, micro-projector and OLED displays). And in general, the non-volatile memory 210 functions to store (e.g., persistently store) data and executable code including code that is associated with the functional components of a browser component 213 and applications, and in one example, a platform 209 for running an interface to host a restricted environment as described earlier. In some embodiments, for example, the non-volatile memory 210 includes bootloader code, modem software, operating system code, file system code, and code to facilitate the implementation of one or more portions of the platform 209 as well as other components well known to those of ordinary skill in the art that are not depicted for simplicity.

In many implementations, the non-volatile memory 210 is realized by flash memory (e.g., NAND or NOR memory), but it is certainly contemplated that other memory types may be utilized as well. Although it may be possible to execute the code from the non-volatile memory 210, the executable code in the non-volatile memory 210 is typically loaded into RAM 203 and executed by one or more of the N processing components 201.

The N processing components 201 in connection with RAM 203 generally operate to execute the instructions stored in non-volatile memory 210 to effectuate the functional components. As one of ordinarily skill in the art will appreciate, the N processing components 201 may include a video processor, modem processor, DSP, graphics processing unit (GPU), and other processing components. In some implementations, the processing components 201 are configured to determine a type of software activated on the user device 200.

The transceiver component 205 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks. In some implementations, the communication of the transceiver component 205 with communication networks enable a location of the user device 200 to be determined.

In some implementations, the user controls 207 are defined in the map of controls. It should be appreciated that the image capturing components 212 and the audio signal capturing components 211 can also be utilised to input user controls, as defined in the map of controls.

Central Server 140/Feed Server 160

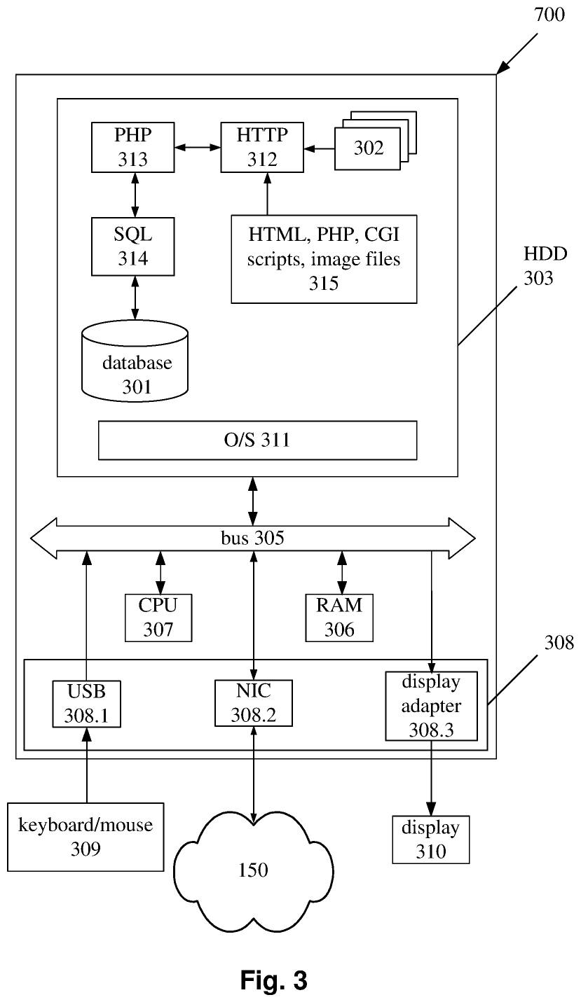

The central server 140 and feed server 160 of any of the examples herein may be formed of any suitable processing device, and one such suitable device is shown in FIG. 3.

In this example, a processing device is provided by a computing system 300 in communication with a database 301, as shown in FIG. 3. The computing system 300 is able to communicate with the user devices 130, and/or other processing devices, as required, over a communications network 150 using standard communication protocols.

The components of the computing system 300 can be configured in a variety of ways. The components can be implemented entirely by software to be executed on standard computer server hardware, which may comprise one hardware unit or different computer hardware units distributed over various locations, some of which may require the communications network 150 for communication. A number of the components or parts thereof may also be implemented by application specific integrated circuits (ASICs) or field programmable gate arrays.

In the example shown in FIG. 3, the computing system 300 is a commercially available server computer system based on a 32 bit or a 64 bit Intel architecture, and the processes and/or methods executed or performed by the computing system 300 are implemented in the form of programming instructions of one or more software components or modules 302 stored on non-volatile (e.g., hard disk) computer-readable storage 303 associated with the computing system 300. At least parts of the software modules 302 could alternatively be implemented as one or more dedicated hardware components, such as application-specific integrated circuits (ASICs) and/or field programmable gate arrays (FPGAs).

The computing system 300 includes at least one or more of the following standard, commercially available, computer components, all interconnected by a bus 305:

1. random access memory (RAM) 306;

2. at least one computer processor 307, and

3. external computer interfaces 308:

a. universal serial bus (USB) interfaces 308.1 (at least one of which is connected to one or more user-interface devices, such as a keyboard, a pointing device (e.g., a mouse 309 or touchpad),

b. a network interface connector (NIC) 308.2 which connects the computing system 300 to a data communications network, such as the Internet 150; and

c. a display adapter 308.3, which is connected to a display device 310 such as a liquid-crystal display (LCD) panel device.

The computing system 300 includes a plurality of standard software modules, including:

1. an operating system (OS) 311 (e.g., Mac, Linux or Microsoft Windows);

2. web server software 312 (e.g., Apache, available at http://www.apache.org);

3. scripting language modules 313 (e.g., personal home page or PHP, available at http://www.php.net, or Microsoft ASP); and

4. structured query language (SQL) modules 314 (e.g., MySQL, available from http://www.mysql.com), which allow data to be stored in and retrieved/accessed from an SQL database.

Together, the web server 312, scripting language 313, and SQL modules 314 provide the computing system 300 with the general ability to allow users of the Internet 150 with standard computing devices equipped with standard web browser software to access the computing system 300 and in particular to provide data to and receive data from the database 301 (for example, data of mobile device software). It will be understood by those skilled in the art that the specific functionality provided by the system 300 to such users is provided by scripts accessible by the web server 312, including the one or more software modules 302 implementing the processes performed by the computing system 300, and also any other scripts and supporting data 315, including markup language (e.g., HTML, XML) scripts, PHP (or ASP), and/or CGI scripts, image files, style sheets, and the like.

The boundaries between the modules and components in the software modules 302 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the processes performed by the computing system 300 may be executed by a module (of software modules 302) or a portion of a module. The processes may be embodied in a non-transient machine-readable and/or computer-readable medium for configuring a computer system to execute the method. The software modules may be stored within and/or transmitted to a computer system memory to configure the computing system 300 to perform the functions of the module.

The computing system 300 normally processes information according to a program (a list of internally stored instructions such as a particular application program and/or an operating system) and produces resultant output information via input/output (I/O) devices 308. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

It should be appreciated that the system 100 shown in FIG. 1 is illustrative, and can be used for carrying out the numerous methods described in the preceding paragraphs. In some of the methods, data processing can be done respectively at the user devices 130 and central server 140, or the data processing can be shared by the user devices 130 and central server 140.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. Persons skilled in the art will appreciate that numerous variations and modifications will become apparent. All such variations and modifications which become apparent to persons skilled in the art, should be considered to fall within the spirit and scope of the invention.

1. A system for carrying out an IBO for a tradeable object in a restricted environment, the system including at least one data processor configured to:
receive, from a user device, an IBR;
process, at the central server, the IBR such that a UIBOID is associated with the IBR;
determine, at the central server, if FM is sufficient to carry out the IBR;
process, at the central server, PE and at least one SE designations for respective objects in the restricted environment;
determine, at the central server, a cbPrice for the PE;
process, at the central server, the IBO;
transmit, from the central server, an OTP resulting from the IBO, enabling a user dashboard to be updated;
process, at the central server, a PCO Stack in accordance with predefined rules; process, at the central server, respective prices of the PE and at least one SE;
update, at the central server, the respective prices of the PE and at least one SE; and
determine, at the central server, if there are changes in the respective prices of the PE and at least one SE,
wherein the PCO Stack is processed by re-sorting PCOs based on firstly, specified price of PCOs, and secondly, chronology of creation of PCOs.

2. The system of claim 1, wherein the IBR comprises:
an IBO;
a TPO; and
a SLO,
wherein the TPO and the SLO are converted to PCOs and placed in the PCO Stack.

3. The system of claim 1, wherein if the FM is insufficient to carry out the IBR, a record will be stored in a game transaction history log, wherein the cbPrice is given a definite value to account for situation variation at prior junctures, wherein the IBO is matched with the cbPrice.

4. The system of claim 1, wherein the dashboard includes details of at least: IBO ID, PE name, nUnits, opening price, current price, take-profit value, stop-loss value, profit/loss, time of IBO, and duration of trade.

5. The system of claim 1, wherein processing of the respective prices of the PE and at least one SE differs depending on a number of SEs, and wherein the processing of the respective prices of the PE and at least one SE is dependent on whether Price Movements are within a pre-determined threshold.

6. A system for carrying out an ICP for a tradeable object in a restricted environment, the system including at least one data processor configured to:
receive, from a user device, an ICR;
process, at a central server, the ICR such that a UIBOID is associated with the ICR;
process, at the central server, the ICR such that a UICOID is associated with the ICR;
process, at the central server, PE and at least one SE designations for respective objects in the restricted environment;
determine, at the central server, a ccPrice for the PE;
process, at the central server, the ICP;
transmit, from the central server, a CTP resulting from the ICP, enabling a user dashboard to be updated;
process, at the central server, a PCO Stack in accordance with predefined rules;
process, at the central server, respective prices of the PE and at least one SE;
update, at the central server, the respective prices of the PE and at least one SE; and
determine, at the central server, if there are changes in the respective prices of the PE and at least one SE,
wherein the PCO Stack is processed by re-sorting PCOs based on firstly, specified price of PCOs, and secondly, chronology of creation of PCOs.

7. The system of claim 6, wherein the UIBOID matches a UICOID, wherein the processing of the ICP enables closure of a prior Open Position, and removal of a TPO and SLO associated with the prior Open Position from the PCO Stack, wherein the dashboard includes details of at least: ICP ID, PE name, nUnits, opening price, closed price, take-profit value, stop-loss value, profit/loss, duration of trade, and time of close.

8. The system of claim 6, wherein the processing of the respective prices of the PE and at least one SE differs depending on a number of SEs wherein the processing of the respective prices of the PE and at least one SE is dependent on whether Price Movements are within a pre-determined threshold.

9. A system for carrying out a PBO for a tradeable object in a restricted environment, the system including at least one data processor configured to:
receive, from a user device, a PBR;
process, at a central server, the PBR such that a UPBOID is associated with the PBR;
process, at the central server, the PBO for storing at a PBO Stack; and
transmit, to the user device, information of the PBO, enabling a user dashboard to be updated,
wherein the PBO Stack is processed by re-sorting PBOs based on firstly, specified price of PBOs, and secondly, chronology of creation of PBOs.

10. The system of claim 9, wherein the PBR comprises:
a PBO;
a TPO; and
a SLO,
wherein the dashboard includes details of at least: UPBOID, PE name, nUnits, scoPrice, current price, take-profit value, stop-loss value, time of order, and duration of order.

11-34. (canceled)
